(19) United States
(12) Patent Application Publication
(10) Pub. No.: US 2003/0195789 A1
(43) Pub. Date: Oct. 16, 2003

(54) Method for incorporating human-based activities in business process models

(76) Inventor: Scott Shyh Guang Yen, San Jose, CA (US)

Correspondence Address: SKJERVEN MORRILL MACPHERSON LLP, 25 Metro Drive, Suite 700, San Jose, CA, 95110, US

(21) Appl. No.: 09/824,175

(22) Filed: Mar. 30, 2001

(51) Int. Cl. G06F 17/60

(52) U.S. Cl. 705/9

(57) ABSTRACT

A method for incorporating human-based or manual activities in computer-based business process models is provided. For this method, a UML-based modeling environment is extended to include activity states to represent human-based or manual steps. At runtime, business process objects transition into activity states in response to events and conditions that have been identified by the model designer. When an activity state is entered, the BPM system generates a respective task for each performer. The BPM system notifies each performer of their task and optionally passes designer specified reference data to each performer. The BPM system then waits for the performers to complete their tasks. As each task completes, the BPM system optionally collects information from the respective task performer. When all tasks have been completed, the BPM system transitions the business process object out of the activity state.

### COMPUTER PROGRAM LISTING APPENDIX

The computer program listing appendix attached hereto consists of two (2) identical compact disks, copy 1 and copy 2, each containing a listing of the software code outlining an exemplary method for incorporating human-based activities in business process models. The contents of the compact disks are a part of the present disclosure, and are incorporated by reference herein in their entireties.

### TECHNICAL FIELD OF THE INVENTION

The present invention relates generally to computer software and to methods for business process management. More particularly, the present invention includes a method that extends business process models to include human-based activities.

### BACKGROUND OF THE INVENTION

A business process management system (BPM system) is a computer system that automates business processes. Business processes are steps that a business undertakes to accomplish some objective, such as hiring an employee or procuring components required for production. BPM systems automate business processes by managing business process objects. A business process object is an entity that exists within the context of a BPM system and represents a business process instance.

As an example, consider the case of a retail business. For this type of application, a BPM system might be constructed to track customer orders. A business process object would represent each order. The BPM system used by the retail business would manage customer orders by manipulating the corresponding business process objects.

BPM systems are typically designed in a way that makes their behavior easy to customize. This allows the same underlying system to be deployed in a range of different environments and applications, such as manufacturing, retail sales, and business to business applications.

To provide this type of flexibility, some BPM systems have adopted a model-driven approach. BPM systems of this type allow model-designers to describe business processes in terms of business process models. A business process model is a formal definition of a business process in a high-level graphical modeling language such as UML (Uniform Modeling Language).

Business process models define the runtime behavior of business process objects using state diagrams. FIG. 1 shows an example of a state diagram of this type. This particular state diagram begins with an initial state where an order is received. The initial state is followed by two states: a first for existing customers and a second for new customers. These two states are followed by a final state where the order is processed.

The connections between states are known as transitions. Model designers define transitions as part of the process of defining state diagrams. In this way, users get to choose the permissible paths through state diagrams.

Objects traverse transitions and move between states in response to events. Events are notification within the BPM system that something has happened in the real world. Customers placing orders and customers canceling orders are two examples of events.

The ability to define objects, state diagrams (including states and transitions) and events provides model designers with a highly flexible and intuitive mechanism for customizing the behavior of model-driven BPM systems. Model designers get to define the entities processed by the BPM systems (in term of objects), the runtime behavior of those entities (state diagrams) and the interaction between the real world and the BPM system (events). This mechanism is even more powerful because it lends itself to creation and manipulation within graphical or visual design environments. This allows users to define state diagrams by drawing, for example. In this way, model-driven BPM systems greatly reduce the need for highly skilled programmers.

One shortcoming of current BPM systems arises when business processes involve human-based activities. As an example, consider the case of an online order taking system. For some systems of this type, incoming orders must be approved by a manager (or other human) before they can be accepted. This might be the case with orders involve large amounts of money, for example. Unfortunately, model-driven BPM systems don't provide a mechanism for modeling human-based activities. As a result, many business processes may be difficult (and in some cases, impossible) to accurately model.

As a result, there is a need for BPM systems that can be extended to include human-based activities. This need is particularly true for business processes that includes a large number of human-based activities or where human-based activities otherwise become the dominant portion of a business process.

### SUMMARY OF THE INVENTION

An embodiment of the present invention provides a method for incorporating human-based or manual activities in business process models. For this method, the modeling environment within a BPM system is extended to allow model designers to add manual steps to business process models. Each manual step is represented by an activity state. Each activity state includes attributes identifying one or more performers for the activity state. For typical implementations, these attributes also allow model designers to associate information, referred to as reference data with each activity states. A range of other attribute types and functions are also supported.

At runtime, business process objects transition into activity states in response to events and conditions that have been identified by the model designer. When an activity state is entered, the BPM system identifies the performers associated with the activity state. The BPM system then generates a respective task for each performer. The BPM system also distributes copies of the reference data to each task.

The BPM system then waits for the performers to complete their tasks. As each task completes, the BPM system collects any reference data that has been changed by the respective performer. When all tasks have been completed, the BPM system transitions the business process object out of the activity state. The particular transition or transitions taken from an activity state may be conditionally based on the reference data collected during the activity sate.

Stated differently, the present invention includes a method for providing a BPM system, the method comprising the steps of receiving an event, causing a business process object to transition to an activity state corresponding to the event, identifying one or more performers for the activity state, and creating a task for each performer.

Other aspects and advantages of the present invention will become apparent from the following descriptions and accompanying drawings.

### BRIEF DESCRIPTION OF THE DRAWINGS

For a more complete understanding of the present invention and for further features and advantages, reference is now made to the following description taken in conjunction with the accompanying drawings, in which:

FIG. 1 is a state diagram as used in a business process model.

FIG. 2 is a block diagram of an Internet-like network shown as a representative environment for deployment of the present invention.

FIG. 3 is a block diagram of a computer system as used within the network of FIG. 2.

FIG. 4 is a block diagram showing the components of a BPM system compatible with an embodiment of the present invention.

FIG. 5 is a state diagram of a business process model including a manual activity. FIG. 6 is a state diagram of a business process model including three manual activities.

FIG. 7 shows the state diagram of FIG. 6 with an additional state to handle a timeout event.

FIG. 8 is a state diagram of a sub-process model invoked by the timeout event of FIG. 7.

FIG. 9 shows the state diagram of FIG. 7 with an additional state to handle a user-defined cancellation event.

FIG. 10 is a state diagram of a business process model including two concurrent manual activities.

FIG. 11 is a state diagram of an activity control model as used within an embodiment of the present invention.

FIG. 12 is a state diagram of a task control model as used within an embodiment of the present invention.

FIG. 13 is a block diagram showing a federation of BPM systems.

### DETAILED DESCRIPTION OF THE PREFERRED EMBODIMENTS

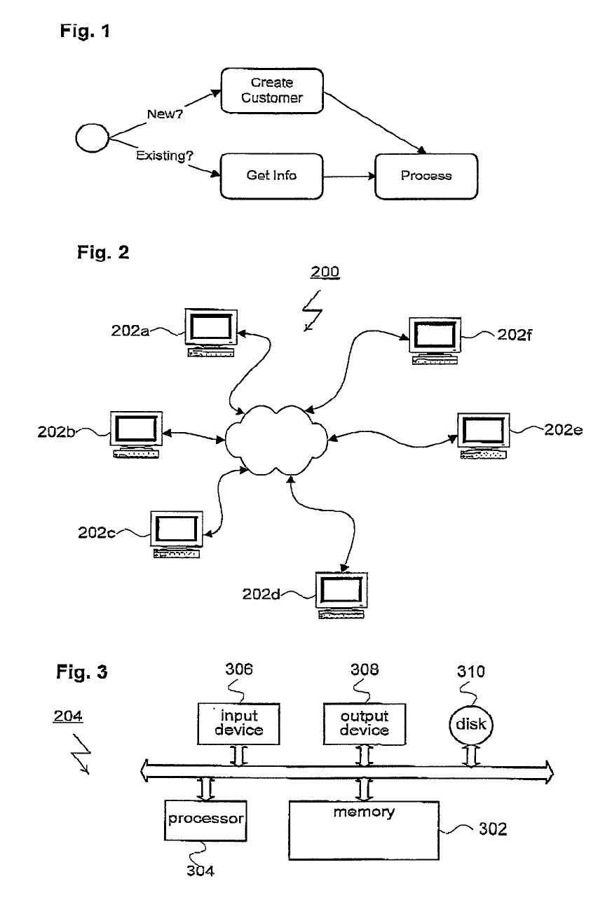

The preferred embodiments of the present invention and their advantages are best understood by referring to FIGS. 1 through 14 of the drawings. Like numerals are used for like and corresponding parts of the various drawings.

Definitions

Activity: a human-based or manual part of a business process is referred to as an activity.

Performer: an individual who is responsible for a portion of an activity is referred to as a performer.

Task: a task is the portion of an activity that is assigned to a performer.

Activity Supervisor: an individual who manages or has responsibility for an activity is referred to as an activity supervisor.

Process Supervisor: an individual who manages or has responsibility for all of the activities within a process is referred to as a process supervisor.

Business Process: steps that a business undertakes to accomplish some objective, such as hiring an employee; acquiring a new customer; fulfilling a customer order; provisioning a new service; enrolling a new partner. For the purposes of this document this definition includes lower-level processes that support businesses, such as processes to synchronize disparate databases, etc. The steps in a business process may be automated, manual or a combination of both.

Business Process Model: A formal definition of a business process in a high-level graphical modeling language.

Business Process Instance: An instance of a business process. For example, the fulfillment of Joe Smith's order is considered an “instance” of the more general order fulfillment business process. Note that each customer order being fulfilled would be an instance of the Order Fulfillment Business Process. Hence, a business process typically will have many instances.

Business Process Object: A computerized representation of a business process instance.

Environment

In FIG. 2, a computer network 200 is shown as a representative environment for an embodiment of the present invention. Computer network 200 is intended to be representative of the complete spectrum of computer network types including Internet and internet-like networks. Computer network 200 includes a number of computer systems, of which computer systems 202a through 202f are representative. Computer systems 202 are intended to be representative of the wide range of large and small computer systems that are used in computer networks of all types.

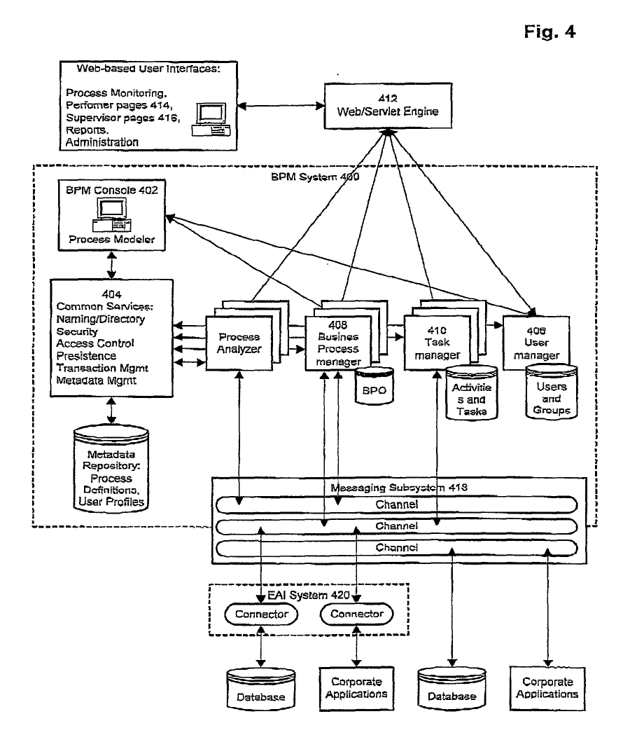

FIG. 3 shows a representative implementation for computer systems 202. Structurally, each computer system 202 includes a processor, or processors 302 and a memory 304 Processor 302 can be selected from a wide range of commercially available or custom to processor 302 and memory 304 Input device 306 and output device 308 represent all types of I/O devices such as disk drives, keyboards, modems, network adapters, printers and displays. Each computer system 202 may also include a disk drive 310 of any suitable disk drive type (equivalently, disk drive 310 may be any non-volatile mass storage system such as “flash” memory).

Overview of Compatible BPM System

An embodiment of the present invention provides a method for incorporating human-based or manual activities in business process models. This method is preferably (but not necessarily) used in combination with a model-driven BPM system. To better describe this method, FIG. 4 shows a model-driven BPM system 400 deployed as part of an EAI system. BPM system 400 is intended to be representative of BPM systems that are suitable for use with the method for incorporating manual activities.

As shown in FIG. 4, BPM system 400 includes a process modeler 402. Process modeler 402 is an interactive interface, preferably graphical, that allows users to create and modify business process models. As described with reference to FIG. 2, users define business process models as collections of states interconnected by transitions. The process models are preferably UML (Uniform Modeling Language) based, with process modeler 402 being a visual environment for manipulating UML constructs.

Businessware server 404 maintains the business process models created by process modeler 402. Process modeler 402 retrieves business business models from businessware server 404 and stores business process models to businessware server 404 on an as-needed basis.

BPM system 400 also includes a user manager 406. User manager 406 allows definitions of performers, groups of performers, activity supervisors and process supervisors to be created, modified and persistently stored. These definitions are available within process modeler 402 for inclusion within business process models.

Business Process Manager 408 is the runtime environment for business process objects within BPM system 400. Business process manager creates 408 business process objects using the business process models maintained by businessware server 404. Each business process objects is an instance of the corresponding business process model. Task Manager 410 helps by adding support for the human-based or manual portions of the business process models.

BPM system 400 interacts with human performers and human supervisors by generating performer pages 414 and supervisors pages 416. Web server 412 (“server” here refers to server software executable on a computer system) provides a web-based (i.e., World Wide Web) interface to BPM system 400 by utilizing performer pages 414 and supervisors pages 416. The two sets of pages are directed at performers and supervisors of BPM system 400, respectively.

Communications channels 418 largely handle the bulk of communications between the components of BPM system 400. Communications channels 418 are preferably configured to provide asynchronous and guaranteed communications. This increases the performance of BPM system 400 by allowing different components (such as task manager 410 and business process manager 408) to work in an independent, asynchronous fashion. Guaranteed communications simplifies the design of BPM system 400 since each component may be designed with the assumption that communications are reliable. Communications channels 418 may be part of BPM system 400 or supplied by the environment in which BPM system 400 operates.

To provide software application integration, BPM system 400 works in combination EAI system 420. EAI system 420 provides an object-oriented interface to third party applications and databases. BPM system 400 allows the interactions between the models exposed by these interfaces to be defined as business process models. In effect the combination of EAI system 420 and BPM system 400 provides a model driven EAI system.

The components that have just been described support business process models of the type traditionally associated with BPM systems. The following sections describe how these components may be used to support business process models that incorporate human-based or manual activities.

Activities

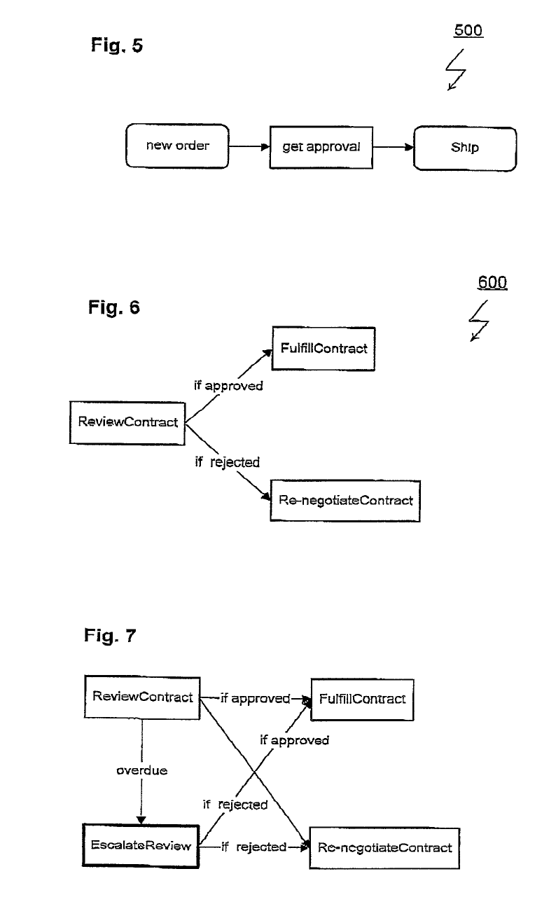

FIG. 5 shows an example of a business process model 500 incorporating a human-based or manual activity. Business process model 500 includes three states. The first state corresponds to the receipt of a new order. The final state corresponds to the order being shipped. These two states represent automated processes. Application programs might perform both of these steps, for example. The second, intermediate state corresponds to the manual step of having the order approved. Manual steps are referred to as activities.

Activity State Semantics

Within process modeler 402, manual steps (such as the second state of business process model 500) are modeled using a construct known as an activity state. Activity states share many of the characteristics of normal states. Normal states are used to model automated processes. The equal treatment of activity states and normal states results in a richly expressive BPM modeling environment.

Like normal states, each activity state may have one or more outgoing transitions. Each transition is associated with an event and, optionally, a condition. The default outgoing transition for an activity state is triggered when a predefined activity completion event is raised. Other (non-default) outgoing transitions are associated with other events. As an example, FIG. 6 shows a state diagram 600 that includes three activity states. The ReviewContract state has two transitions. Both transitions are associated with the activity completion event. The first transition is conditioned upon the contract being approved. Thus, this transition is chosen if the contract reviewed in the first state is approved. The second transition is conditionally traversed if the contract is rejected. This transition leads to the Re-negotiateContract state.

FIG. 7 extends the example of FIG. 6 by adding a third transition to the initial state. The third transition is associated with a time-out event. This transition is traversed if the contract review process becomes overdue (times out). In this case, the third transition is taken to invoke the escalation sub-model (represented in FIG. 7 as a nested state).

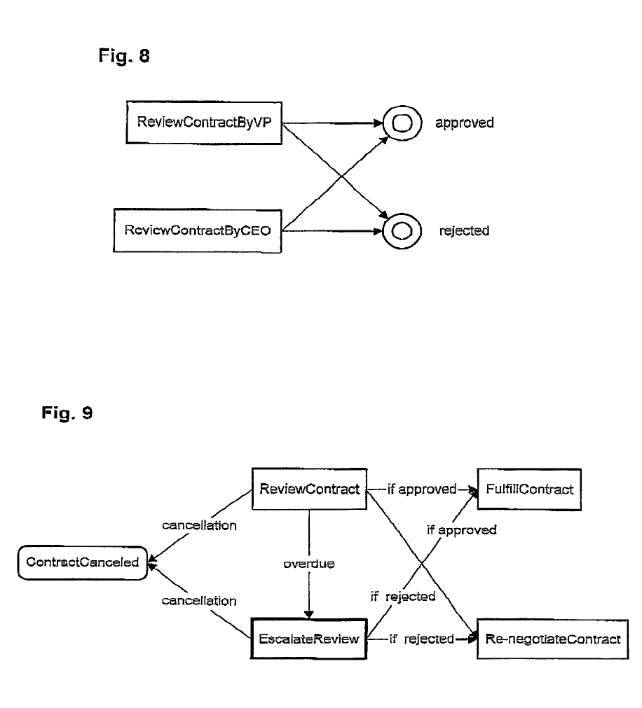

FIG. 8 shows the escalation sub-model. Within this sub-model, the escalated review process forwards the contract directly to a vice president and CEO. Either one of them can approve or reject the contract. The review results are indicated by two termination states: approved and rejected.

The activity complete and the time out events are both pre-defined. BPM system 400 also allows the user to define additional events as needed. This is shown, for example, in FIG. 9. Within FIG. 9, a ContractCanceled state has been added to the state diagram last seen in FIG. 7. The ContractCanceled state is implemented as a normal (i.e., non-activity state) and is reachable via transitions from the ReviewContract and EscalateReview activity states. In each case, the transition to the ContractCanceled state is traversed in response to a receipt of a user-defined cancellation event. Receipt of this event terminates the ReviewContract or EscalateReview activity states and leads immediately to the ContractCanceled state.

For the particular implementation being described, activity states are not permitted to be the first or last (Start or End) State of a business process model.

Activity State Definition

The activity state extends the normal state to include the following attributes:

1) Name: each activity may have a name.

2) Description: a string describing the nature of the activity.

3) Priority: a value indicating the priority of an activity state within its containing process. The priority may be used to communicate with users (e.g., by prioritizing or ordering communications such as email).

4) Performer: the user or group of users who may perform the activity.

5) Reassignable: a boolean value each indicating whether the performer of an activity may reassign the activity to another performer. If the value is false only the process/activity supervisor has such permission.

6) Time limit: a value indicating the deadline required for completion of the activity.

7) Details: a string containing a URL pointing to a description of the activity.

8) Reference data: data that is useful to the performers who will complete the activity. Reference data is described in greater detail below.

In general, it should be appreciated that not all implementations will include this exact set of attributes. In other cases, additional attributes may also be included.

Within an activity state, reference data refers to information that is intended to help performers complete their tasks. There are two kinds of reference data: Business process object reference data and activity reference data.

Business process object reference data is a portion of a business process object that a model designer wants to make available to the performers of an activity. For example, business process objects used to model a stock purchase process might include attributes for stock price and stock quantity. The model designer might want to make these attributes available to the performers within activity states for this process.

Activity reference data refers to data that is useful only within an activity state. For the stock purchase process example, activity reference data might include a purchase limit or a report string. Activity reference data is defined on an activity state by activity state basis. This means that activity reference data is not shared between different activity states, even if they are associated with the same business process object. This differs from business process object data because business process object data may be shared between any or all of the activity states associated with a business process object.

Both activity reference data and business process object reference data may be configured to be read-only or editable. Read-only reference data cannot be changed by the performers of an activity. Editable reference data can be changed. This can be used, for example, to allow performers to enter comments or other information.

Activity State Runtime

Within BPM system 400, the runtime environment for business process objects is provided by a cooperative effort between Business Process Manager 408 and Task Manager 410. Business Process Manager 408 creates business process objects using the business process models defined in process modeler 402. Each business process object tracks a business process instance as it moves through its associated state diagram.

When an event causes a business process object to transition into an activity state, Business Process Manager 408 prepares and sends an activityCreate event to Task Manager 410. The activityCreate event includes an ActivitySpec data structure describing the activity state. This includes the performer specification, activity reference data and business process object reference data that are associated with the activity state.

Task Manager 410 controls the runtime behavior of activity states using activity control model 1100 of FIG. 11. The activityCreate transition within activity control model 1100 is traversed when Task Manager 410 receives an activityCreate event published by Business Process Manager 408. During this transition, task manager 408 uses the performer specification included with the activityCreate event to resolve or identify the performers for the activity state.

For each identified performer, Task Manager 410 generates an object known as a task. Each task object records progress for the portion of an activity that is assigned to its performer. Task Manager 410 includes a copy of all activity reference data and business process object reference data in each generated task.

After completing the activityCreate transition, the activity state instance stays in the WaitForCompletion state. It remains in this state until all of the previously generated tasks have completed. As each task is completed, task manager collects any changes made to the activity reference data and business process object reference data distributed to that task. In this way, Task Manager 410 collects input from all task performers.

When all tasks for a particular activity have completed, Task Manager 410 generates and publishes an activityComplete event to Business Process Manager 408. The activityComplete event includes the activity reference data and business process object reference data that have been collected by Task Manager 410. The activityComplete event also includes other data associated with the activity state, such as the identities of the performers of the activity state. Task Manager 410 then generates an internal taskcomplete event to cause the activity state instance to transition to the Complete state.

In some cases, the activity instance may receive an activityTerminate event from Business Process Manager 408. This happens, for example in cases when an activity times out. User defined conditions may also trigger the activityTerminate event.

In these cases, the activity state instance terminates any incomplete tasks and traverses the terminate transition. In these cases, no event will be sent to Business Process Manager 408 and any collected reference data will is discarded.

Business Process Manager 408 receives the activityComplete event published by Task Manager 410. Business Process Manager 408 then updates the business process object associated with the just-completed activity state to incorporate any changes that were made to the business process object reference data during execution of the activity state. Business Process Manager 408 also selects the next state for the business process object. In some cases, the transitions out of an activity state will be conditioned upon the activity reference data or business process object reference data associated with an event.

In general, it should be appreciated that this particular division of labor between Business Process Manager 408 and Task Manager 410 is somewhat arbitrary. For other implementations, these functions could be combined into a single module or subdivided in other ways.

Concurrent Activity States

Business Process Manager 408 is configured to allow only a single instance of an activity state to be active within a given process instance at any point in time. This prevents a single step from being simultaneously performed by different performers.

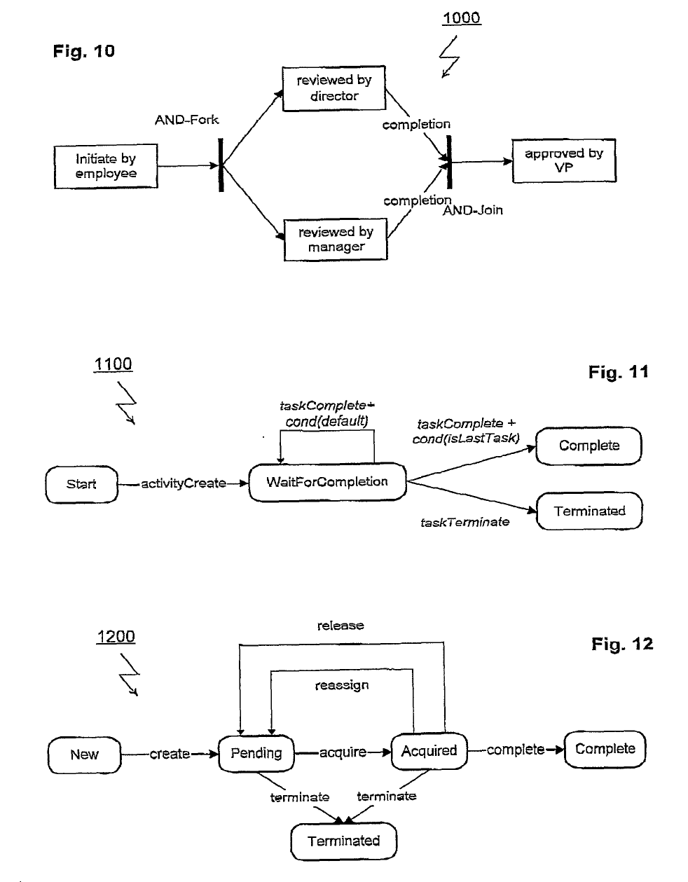

A single process instance may, however, have multiple instances of different activity states that are concurrently active. A case like this is illustrated by business process model 1000 of FIG. 10. Business process model 1000 has four activity states. Two of these “review by director” and “review by manager” are configured to occur concurrently. Completion of the first state of business process model 1000 triggers both of these concurrent activity states.

To support concurrent activity states, BPM system 400 is configured to allow events to be targeted to specific activity states (this differs from traditional UML modeling where each event is delivered to each active state). Targeting, ensures that events don't get applied to the wrong state (e.g., as would be the case if the completion event for “review by director” were applied to “review by manager’). BPM system 400 provides the following method for targeting events to activity states:

1) Event publishers can optionally include a parameter in an event that indicates the name of the activity state to which the event is directed.

2) Business Process Manager 408 forwards an event of this type to the active activity states that have the name specified by the activity parameter.

Activity Transition Transaction Protection

All components of BPM system 400 carefully handle transactions in order to guarantee system integrity. A transition between activity states is encapsulated in an atomic transaction (“atomic” here meaning that all steps of the transaction are guaranteed to succeed or the transaction is rolled back (undone)). The transaction consists of the following steps performed by Business Process Manager 408:

1) Business Process Manager 408 pre-processes the data (e.g., activity reference data and business process object reference data) returned in the activity completion event.

2) Business Process Manager 408 then selects one or more outgoing transitions of the activity state.

3) Business Process Manager 408 then executes any actions that are associated with the one or more transitions selected in the previous step. Business Process Manager 408 also executes any entry action that it associated with the destination state.

4) Business Process Manager 408 then updates the business process object associated with the just-completed activity state to incorporate any changes that were made to the business process object reference data of the activity state.

5) Business Process Manager 408 then generates and sends an activityCreate event to Task Manager 410 to dispatch the destination activity.

The single-transition transaction guarantees either all the five steps occur successfully or none upon errors.

Tasks

As mentioned, Task Manager 410 generates an object, referred to as a task, for each performer of an activity state. Task Manager 410 transitions its task objects through a state diagram known as a task control model. The position of a task object within the control model reflects the status of the task from creation to assignment to completion. The task object includes a series of control methods. Each method provides an interface that allows performers to control the status of their task and its position within the task control model.

The attributes of the task object include:

1) Reassignable: The reassignable attribute is a boolean value each indicating whether the originally assigned performer can re-assign the task to someone else. Business Process Manager 408 initializes the reassignable attribute to be equal to the reassignable attribute of the associated activity state.

2) Performer: each task has an associated performer. The performer may be a particular user or a group. In the group case, one of the group members is expected to perform the task.

3) State. Each task exists in one of four states: pending, acquired, completed, or terminated.

The control methods of the task object include:

1) Acquire. A performer or a process/activity supervisor may invoke the inquire method to inform Task Manager 410 that they have claimed ownership of a task. A user can only acquire a task that is:

directly assigned to him or her,

assigned to a group to which he or she belongs, or

assigned to a role that he or she can assume.

2) Reassign. A performer or a process/activity supervisor may invoke the reassign method to cause Task Manager 410 to change ownership of a task. Performers are not allowed to reassign their tasks unless the reassignable attribute of the task is set to true.

3) Release. A performer may invoke the release method to cause Task Manager 410 to return a previously acquired task. This is particularly useful to release a task back to a group task list and allow other group members to acquire it.

4) Complete. A performer may invoke the complete method to inform Task Manager 410 that a task has been completed.

Task Control Model

FIG. 11 shows a state diagram 1100 corresponding to the task control model. Within state diagram 1100, the create transition is traversed each time Task Manager 410 creates a new task. During creation, Task Manager 410 initializes each task to reflect the attributes of the associated activity state including activity and business process object reference data.

Once initialized, Task Manager 410 marks each task as being in the pending state. In this state, the performers for tasks have been at least partially resolved (in some cases, the specific identity of a performer will not be known until the performer accepts the task). The performers, however, have yet to acknowledge or otherwise take responsibility for their tasks.

The pending state has two possible outgoing transitions. The acquire transition is traversed when a performer invokes the task's acquire method. This informs Task Manager 410 that the performer has acquired or taken responsibility for the task. Task Manager 410 marks each task making this transition as being in the acquired state.

The terminate transition out of the pending state occurs when a task is terminated. This can happen when a task times out or in response to a user defined event.

The acquired state has four possible outgoing transitions. The complete transition is traversed when a performer invokes the task's complete method to inform Task Manager 410 that the task is finished. Task Manager 410 marks each task making this transition as being in the complete state. When a task enters the complete state, it generates a task complete event. The task complete event includes any changes that the performer has made to activity reference data or business process object reference data. As previously described, Task Manager 410 aggregates the changed reference data all of the task associated with an activity state for return to Business Process Manager 408.

The terminate transition out of the acquired state occurs when a task is terminated. This can happen when the time limit for a task expires (task timeout) or in response to a user defined event.

The reassign transition out of the acquired state occurs when a performer invokes the task's reassign method. A performer or a process/activity supervisor may invoke the reassign method to cause Task Manager 410 to change ownership of a task. Task Manager 410 marks each state making this transition as being in the pending state.

The release transition out of the acquired state occurs when a performer invokes the task's release method. A performer may invoke the release method to cause Task Manager 410 to return a previously acquired task. This is particularly useful to release a task back to a group task list and allow other group member to acquire it. Task Manager 410 marks each state making this transition as being in the pending state.

Performance and System Throughput

BPM system 400 uses a range of techniques to maximize performance and system throughput. As previously described business process objects transition between states in response to events. BPM system 400 encapsulates these transitions as transactions to ensure system integrity.

To increase throughput, BPM system 400 may be configured to include multiple transitions within a single transaction. For one method, BPM system 400 keeps a running count of the number of completed transitions. When the count reaches a predetermined number n, BPM system 400 initiates a transaction processing for the last n transitions. BPM system 400 then restarts the running count from zero. In this way, BPM system 400 batches transitions even when those transitions involve different business process objects. Batching transition not only shorten transactions, but may also reduce number of updates to business process objects in the repository. For example, two subsequent modifications of an attribute become one update.

Business Process Manager 408 uses an update list to avoid long transactions caused by multiple transitions. The update list is a queue of business process objects that have been changed or modified but have yet to be stored persistently. In cases where a business process object is involved in multiple transitions, it may have multiple changes to the same attributes. Use of the update list means that intermediate changes to a business process object may never have to be stored persistently. Shorter transactions result in better concurrency and overall system throughput, as operations are less likely to block each other.

Communication between Business Process Manager 408 and Task Manager 410 is done via guaranteed (i.e. transactional) event publication. Asynchronous communication results in better performance and system throughput, as one component does not wait for completion of a service provided by the other component. In addition, events published by Business Process Manager 408 to Task Manager 410 are not sent until the model transaction succeeds. This mechanism ensures that each individual event reaches Task Manager 410 and is not duplicated (i.e., is received once and is not received multiple times). This ensures that Task Manager 410 does not create duplicated activities and tasks. The same applies to the communication from Task Manager 410 to Process Business Manager 410.

Scalability

As previously mentioned, the division of labor between Business Process Manager 408 and Task Manager 410 is somewhat arbitrary. This means that the same tasks could be performed by different architectures, such as a combination of Business Process Manager 408 and Task Manager 410. It should be noted however, that the described architecture does provide certain advantages that might not be realized with other implementations.

One of these advantages is the ability to shut down Business Process Manager 408 without requiring a concurrent shutdown of any task managers 410. Performers interact directly with Task Manager 410. This means that, in at least some cases, Business Process Manager 408 may be shutdown (for maintenance or other reason) without the shutdown being noticeable to the performers.

The division of labor between Business Process Manager 408 and Task Manager 410 also makes BPM scaleable for large-scale enterprise deployment. As shown in FIG. 4, multiple business process managers 408 and multiple task managers may be used for load balancing. As an organization grows, more business process managers 408 and task managers 410 may be added to the infrastructure.

Task Managers 408 are extremely stable and easy-to-maintain; no matter how many process models and Business Process Managers 408 are deployed. Task Managers 410 do not subscribe to any user-defined types. As a result, any schema or model changes do not require Task Managers 410 to be restarted.

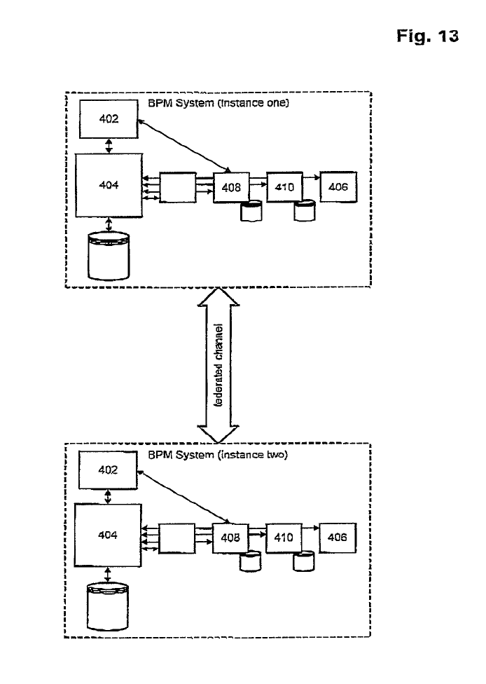

BPM system 400 has strong federation support over its distributed architecture. As shown in FIG. 13, typical federated environment consists of two or more instances of BPM system 400 executing on computer systems in different environments that are networked together. In such a system, Business Process Managers 408, Task Managers 410 and the web-based GUI (such as Performer Pages) in different instances of BPM system 400 communicate through federated channels. This allows Business Process Managers 408 to, for example, invoke task managers 510 on a remote system.

Security

BPM system 400 is configured to enforce security at several points. Businessware server 404 maintains an access control list (ACL) for each business process model. Users of process modeler 402 must supply credentials that match the appropriate ACL before being allowed access to a business process model.

Web server 412 is configured to authenticate each performer using information managed by user manager 406. Once authenticated, web server 412 uses performer pages 414 to supply each performer with their task list. Task Manager 410 prevents performer from accessing tasks assigned to others.

BPM system 400 is configured to support two special classes of users: process supervisors and activity supervisors. These two user classes have special privileges to ensure smooth execution of process models. For example, a supervisor may want to reassign an overdue task to a different performer. The difference between process supervisors and activity supervisors is the scope of responsibility: process supervisor have responsibility and privileges over entire process models. Activity supervisors, on the other hand, have responsibility and privileges over particular activities.

Conclusion

Although particular embodiments of the present invention have been shown and described, it will be obvious to those skilled in the art that changes and modifications may be made without departing from the present invention in its broader aspects, and therefore, the appended claims are to encompass within their scope all such changes and modifications that fall within the true scope of the present invention.

What is claimed is:

1. A method for creating a business process model, the method comprising the steps of:
defining an activity state, the activity state corresponding to a human-based or manual step; and
identifying one or more performers for the activity state.

2. A method as recited in claim 1 further comprising the step of defining reference data, the reference data being information that is to be made available to the performers of the activity state.

3. A method as recited in claim 2 wherein the reference data is made exclusively available to the performers of the activity state.

4. A method as recited in claim 2 wherein the reference data is also made available to the performers of a second activity state.

5. A method as recited in claim 1 further comprising the step of designating the activity state as reassignable to indicate that may be moved between performers.

6. A method as recited in claim 1 wherein the business process model is created using extended UML (Universal Modeling Language) constructs.

7. A method for providing a BPM system, the method comprising the steps of:
receiving an event;
causing a business process object to transition to an activity state corresponding to the event;
identifying one or more performers for the activity state; and
creating a task for each performer.

8. A method as recited in claim 7 further comprising the steps of:
waiting for each task to be completed; and
causing the business process object to transition from the activity state.

9. A method as recited in claim 7 further comprising the step of providing each performer with reference data for the activity state.

10. A method as recited in claim 9 wherein the reference data is made exclusively available to the performers of the activity state.

11. A method as recited in claim 10 wherein the reference data is also made available to the performers of a second activity state.

12. A method as recited in claim 9 further comprising the step of retrieving modified reference data from one or more of the performers of the activity state.

13. A method as recited in claim 12 further comprising the step of conditionally selecting a transition out of the activity state based on the retrieved modified reference data.

14. A method as recited in claim 7 further comprising the steps of:
receiving a second event; and
applying the second event to the activity state only if the event is targeted to the activity state.
